(19) United States
(12) Patent Application Publication
(10) Pub. No.: US 2015/0363037 A1
(43) Pub. Date: Dec. 17, 2015

(54) CONTROL METHOD OF TOUCH PANEL

(71) Applicant: TIANJIN FUNAYUANCHUANG TECHNOLOGY CO.,LTD., Tianjin (CN)

(72) Inventors: PO-SHENG SHIH, New Taipei (TW); CHIEN-YUNG CHENG, New Taipei (TW); CHUN-LUNG HUANG, New Taipei (TW); PIN-LUNG LIN, New Taipei (TW)

(21) Appl. No.: 14/733,979

(22) Filed: Jun. 9, 2015

(30) Foreign Application Priority Data
Jun. 11, 2014 (CN) 201410257060.1

(51) Int. Cl. G06F 3/041; G09G 5/18

(52) U.S. Cl. CPC G06F 3/0416; G09G 5/18

(57) ABSTRACT

A control method of a touch panel is provided. In the method, the touch panel senses a plurality of touch signals in succession on a timeline generated by a continuous touch on the surface of the touch panel, converts the plurality of touch signals to a plurality of touch coordinates, a first touch track is formed by the plurality of touch coordinates. The touch panel determines if there is a first touch signal sensed on the boundary. The touch panel determines if there is a second touch signal sensed on the timeline in a preset time threshold. The touch panel obtains a second touch track beginning from the second touch signal, and fits the first touch track and the second touch track into one complete touch track, or recognizes the first touch track and the second touch track as two independent tracks.

### CROSS-REFERENCE TO RELATED APPLICATIONS

This application claims priority to Chinese Patent Application No. 201410257060.1, filed on Jun. 11, 2014, the disclosure of which is incorporated herein by reference.

### FIELD

The present disclosure relates to a control method of a touch panel.

### BACKGROUND

With the developing of the touch technology, a touch panel of a portable computer can be used not only for clicking and typing, but also for inputting a handwriting or a gesture. User can set and operate different touch modes corresponding to different areas of the touch panel. For example, a vertical scrolling function can be set on a right edge of the touch panel, and an application program listing function can be set at an upper edge of the touch panel.

There are non-touch areas or non-signal areas in the touch panel. An operation interruption can be caused by straying into the non-touch area when user's touch shifts drastically, and one continuous operation will be recognized as two operations by the touch panel due to the interruption, which may cause a false operation. For example, in the gesture operation mode, when the user continuously drags an icon shown on the display screen and moves the finger into the non-touch area at the upper edge of the touch panel, the icon cannot be moved to a target place as the users expected, but the application program listing function may be activated. When the portable computer has a large-sized touch panel, finger touch range is too large. It is easy to cause the false operation by touches straying into the non-touch area.

### BRIEF DESCRIPTION OF THE DRAWINGS

Implementations of the present technology will now be described, by way of example only, with reference to the attached figures.

FIG. 1 is a structural view of an embodiment of a portable computer including a touch panel.

FIG. 2 is a structural view of an embodiment of the touch panel.

FIG. 3 is a flowchart of one embodiment of a control method of the touch panel.

FIG. 4 is a structural view of a user's operation recognized by the control method of the touch panel.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprise” or “comprising” when utilized, means “include or including, but not necessarily limited to”; it specifically indicates open-ended inclusion or membership in the so-described combination, group, series, and the like.

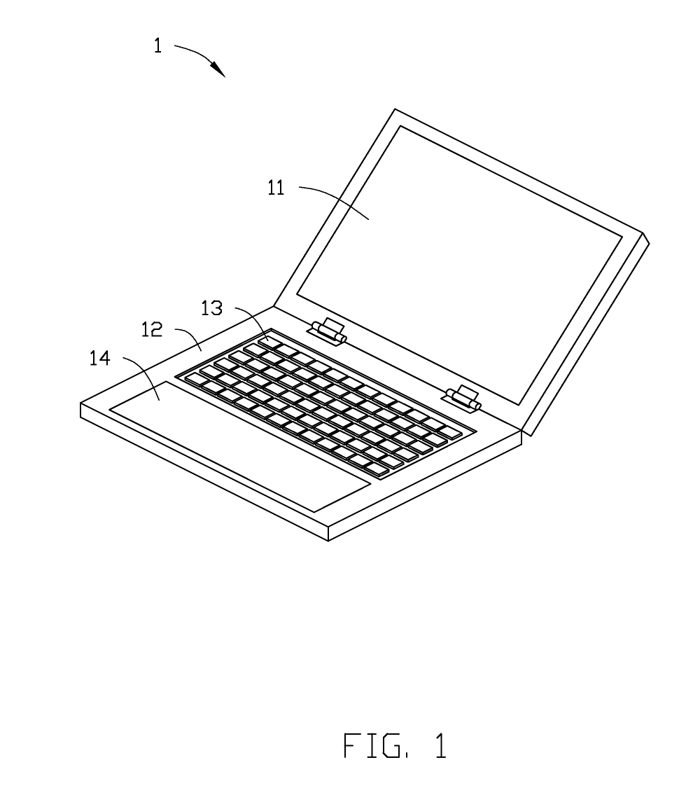

Referring to FIG. 1, one embodiment provides a portable computer 1. The portable computer 1 comprises a display screen 11, a base assembly 12, a keyboard 13 and a touch panel 14. The base assembly 12 is connected with the display screen 11. The keyboard 13 and the touch panel 14 are both located on a surface of the base assembly 12.

The display screen 11 is electrically connected to the base assembly 12 via a data line. The display screen 11 is used to display the data, for example, an image and a text information, output from the base assembly 12. The display screen 11 can be mechanically connected to the base assembly 12 through a hinge. The display screen 11 and the base assembly 12 are axially rotatable around the hinge. The base assembly 12 defines the surface having a left side and a right side. The keyboard 13 and the touch panel 14 are substantially coplanar with each other on the surface. The keyboard 13 is electrically connected to the base assembly 12 through a data line. The keyboard 13 has a length extends from the left side to the right side on the surface. The touch panel 14 can be a large-sized touch panel having a substantially same length to the keyboard 13. In other words, the touch panel 14 can have a length extending from the left side to the right side on the surface of the base assembly 12, whereby a major part of the surface of the base assembly 12 is covered by the keyboard 13 and the touch panel 14. The touch panel 14 can sense touch signals on the surface of the touch penal 14, and can detect the current changes or voltage changes corresponding to the touch signals, and calculate the touch coordinates according to the current changes or voltage changes. The touch panel 14 having the large size can accomplish various touch operations, such as but not limit to, cursor controlling, gesture controlling, handwriting, or painting. The portable computer 1 can be but not limited to a notebook computer, laptop computer, or a notepad computer.

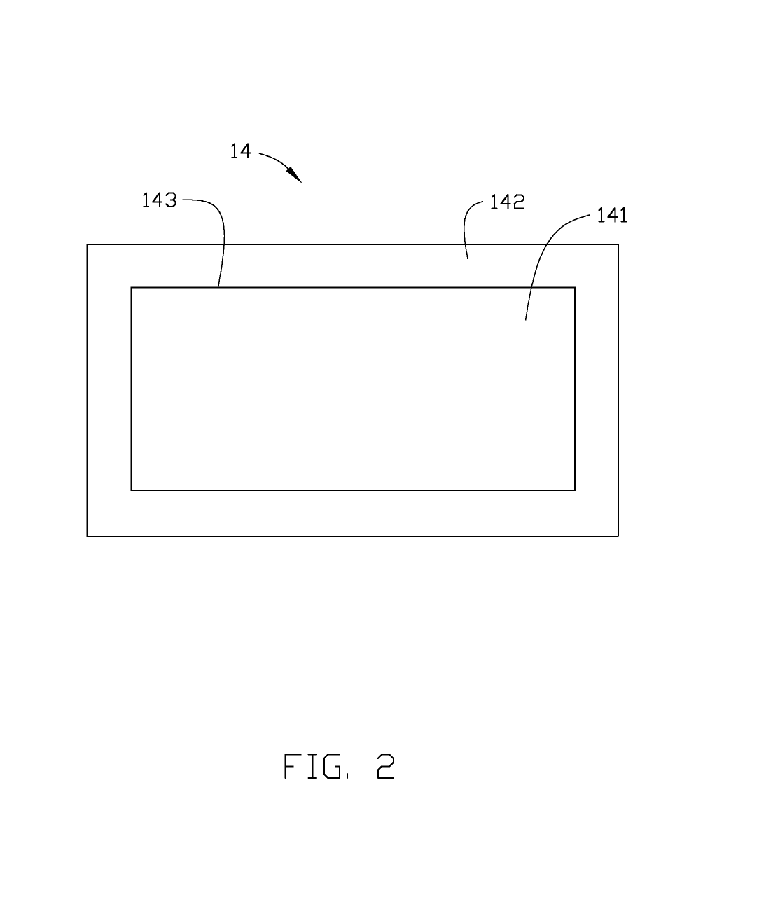

Referring to FIG. 2, the touch panel 14 comprises a touch area 141 and a non-touch area 142. The touch area 141 can sense touch signals. The non-touch area 142 cannot sense the touch signals. The touch area 141 can be divided into a plurality of touch sub-areas with different functions, such as: a mouse touch area, a handwriting touch area, and a gesture touch area, that has different touch modes. The plurality of touch sub-areas can be pre-divided by hardware or can be virtual areas defined by software. The non-touch area 142 is defined as an edge of the touch panel 14, around the touch area 141. The touch panel has a boundary 143 between the touch area 141 and the non-touch area 142, used to separate the touch area 141 and the non-touch area 142. The boundary 143 can sense touch signals. The shape of the boundary 143 can be in accordance with the shape of the touch area 141 of the touch panel 14. The shape of the touch area 141 may be square, rectangular, circular or other shapes. The boundary 143 can further comprise a plurality of sub-boundaries. The plurality of sub-boundaries are sequentially connected with each other to form the boundary 143. In one embodiment, the boundary 143 is a closed rectangular or square frame around the touch area 141.

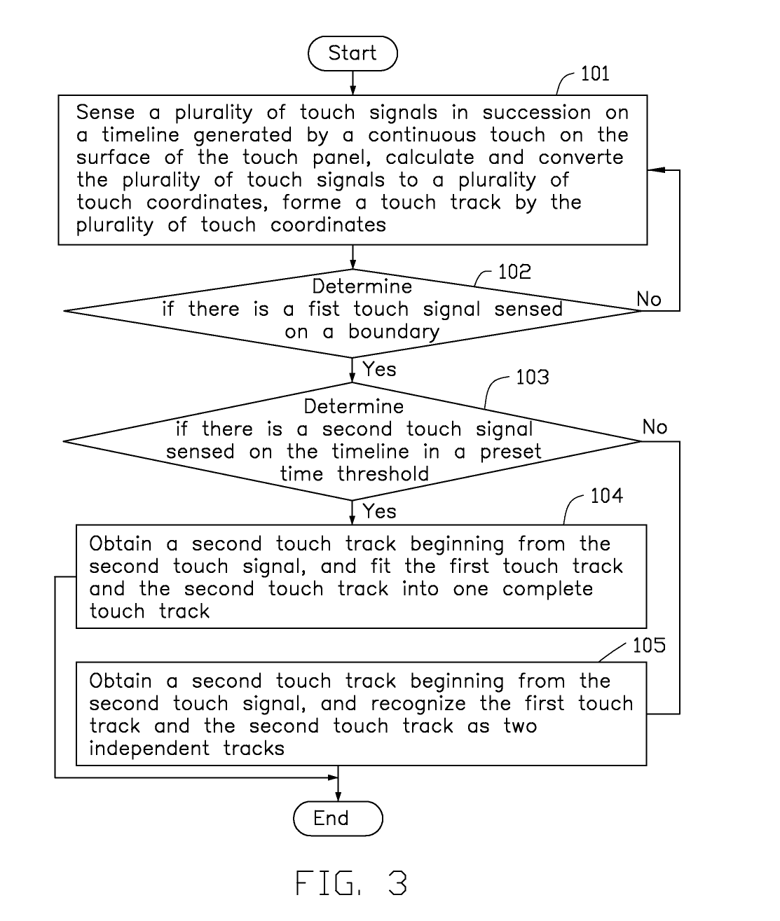

Referring to FIG. 3, a flowchart is presented in accordance with an example embodiment as illustrated. The embodiment of a control method of touch panel 100 is provided by way of example, as there are a variety of ways to carry out the method. The method 100 described below can be carried out using the configurations illustrated in FIGS. 1 to 4 for example, and various elements of these figures are referenced in explaining example method 100. Each block shown in FIG. 3 represents one or more processes, methods, or subroutines carried out in the exemplary method 100. Additionally, the illustrated order of blocks is by example only and the order of the blocks can be changed. The exemplary method 100 can begin at block 101. Depending on the embodiment, additional steps can be added, others removed, and the ordering of the steps can be changed.

At block 101, the touch panel 14 senses a plurality of touch signals in succession on a timeline generated by a continuous touch on the surface of the touch panel 14, calculates and converts the plurality of touch signals to a plurality of touch coordinates, a first touch track is formed by the plurality of touch coordinates.

At block 102, the touch panel 14 determines if there is a first touch signal sensed on the boundary 143; if there is the first touch signal on the boundary 143, a block 103 is proceed; otherwise the block 101 is proceed again to sense the touch signals.

At block 103, the touch panel 14 determines if there is a second touch signal sensed by the touch panel 14 on the timeline in a preset time threshold, the second signal is generated after the first signal on the timeline; if there is the second touch signal generated after the first signal on the timeline in the preset time threshold, a block 104 is proceed, otherwise the block 105 is proceed.

At block 104, the touch panel 14 obtains a second touch track beginning from the second touch signal, and fits the first touch track and the second touch track into one complete touch track.

At block 105, the touch panel 14 obtains a second touch track beginning from the second touch signal, and the first touch track and the second touch track are recognized as two independent tracks.

At block 101, the touch panel 14 continuously senses the touch signals occurred on the touch area 141. Thus, the plurality of touch signals are generated in succession by time (i.e., on the timeline). Each touch signal corresponds to a touch coordinate on the touch area 141. The touch track is a continuous track formed by the plurality of touch coordinates calculated from the plurality of touch signals in succession on the timeline. The touch track corresponds to the track of the finger/touch tool moving on the touch panel 14. The touch signals recognized as belonged to one touch track are in succession by time. Once there is a break (e.g., no signal is sensed in a given time) on the timeline, an end of the touch track is determined. The touch panel 14 may determine the touch mode and perform the touch operation according to the touch track. The touch mode may be, but are not limited to, a mouse touch mode, a handwriting touch mode, or a gesture touch mode. The mouse touch mode may be but not limited to a cursor clicking or an icon dragging mode. The touch operation is an action performed under a specific touch mode, such as an icon dragging, handwriting, or gesture recognizing.

At block 102, if the coordinate of the first touch signal is on the location of the boundary 143, the first touch signal is sensed on the boundary 143.

At block 103, the second touch signal is the signal that is sensed after the first signal on the timeline in the preset time threshold.

When user touches the touch panel 14, there is a possibility that user moves the finger into the non-touch area 142, and the finger stays in the non-touch area 142 for a while. There are two situations, one is the user's intention to finish the last touch, the other is the mis-touch of the non-touch area 142. The preset time threshold corresponds to the time the finger staying in the non-touch area 142 and is used to distinguish the two situations. The time the finger staying in the non-touch area 142 is the time the touch signals not sensed by the touch panel 14. In one embodiment, the preset time threshold is ranged from about 10 ms to about 1000 ms. In one embodiment, the preset time threshold is ranged from about 100 ms to about 300 ms. In another embodiment, the preset time threshold is about 200 ms. Touch tracks before and after the second touch signal sensed by the touch panel 14 can be determined as one continuous operation based on a same touch mode or two independent operations based on different touch modes according to the preset time threshold.

Whether the second touch signal is sensed by the touch panel 14 in the preset time threshold can be determined by a counting timer or a count down timer.

In one embodiment, a method for determining whether the second touch signal is in the preset time threshold by the counting timer includes: step(1), starting the counting timer when the first touch coordinate of the first touch signal is located on the boundary 143; step(2), stopping the counting timer when the second touch signal is sensed to calculate the time period between the starting and the stopping; step(3), comparing the time period with the preset time threshold.

In another embodiment, a method for determining whether the second touch signal is in the preset time threshold by the count down timer includes: step(1), presetting a count down timer, a working time of the count down timer is the preset time threshold; step(2), starting the count down timer when the first touch coordinate of the first touch signal is located on the boundary 143; step(3), determining whether a second touch coordinate of the second touch signal is located on the boundary 143 during the working time of the count down timer.

At block 104, when the second touch signal is sensed by the touch panel 14 in the preset time threshold, the touch panel 14 continuously senses the touch signals occurred after the second touch signal until the end of the touch track is determined (i.e., the break in the given time occurs). The touch signals occur after the second touch signal in succession on the timeline are calculated and converted to another plurality of touch coordinates to form the second touch track. A continuous touch track in the non-touch area 142 is fitted according to the touch tracks before and after the second touch signal sensed by the touch panel 14 (i.e., the first touch track and the second touch track). The touch mode of the fitted touch track is same with the touch mode of the touch track before the second touch signal sensed by the touch panel 14. One operation under a same touch mode is performed based on the one complete touch track.

At block 105, the first touch track and the second touch track are recognized as two independent tracks. The first touch track and the second touch track can correspond two independent touch modes. The two independent touch modes can correspond two independent touch operations. The two independent touch operations can be operated respectively corresponding to two different touch modes.

In one embodiment, the shape of the boundary 143 is a closed square, comprising four sub-boundaries. Specifically, the sub-boundary that the first touch signal located sensed on at block 102 is same with the sub-boundary the second touch signal sensed on at block 103.

The control method of a touch panel of the present embodiment has the following advantages. When the user operates a continuous touch on the touch panel, the control method of the touch panel can avoid operation interruption and misoperation caused by straying into a non-touch area when user's touch shifts drastically.

### Example 1

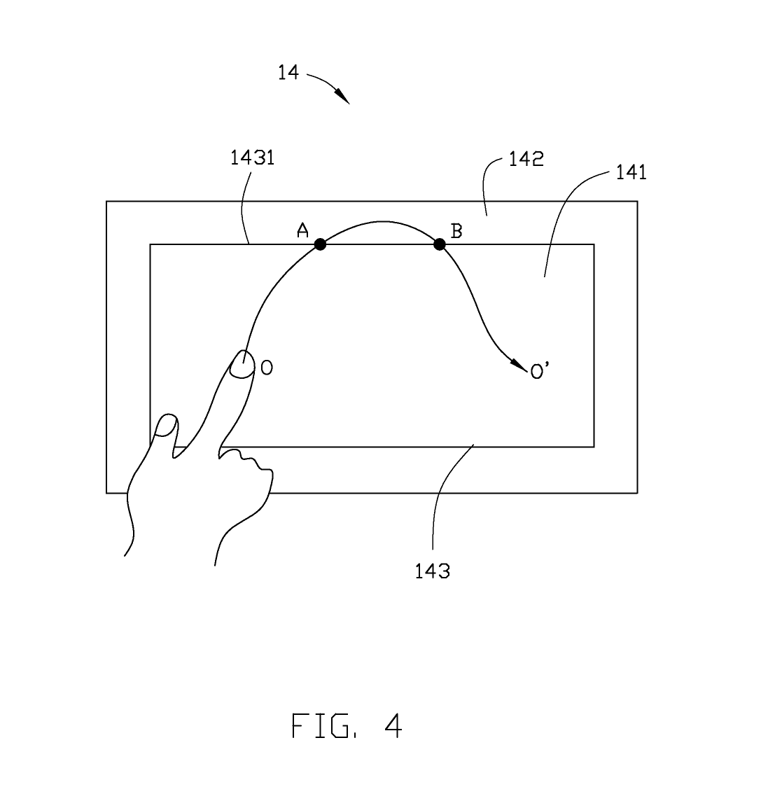

Referring to FIG. 4, a touch track are formed by user's continuously touching of the surface of the touch panel 14 from touch coordinate O, passing touch coordinate A and touch coordinate B, to touch coordinate O′. The touch coordinate O and the touch coordinate O′ are located on the touch area 141. The boundary 143 comprises four sub-boundaries. One sub-boundary of the four sub-boundaries is sub-boundary 1431. The touch coordinate A and the touch coordinate B is located on the sub-boundary 1431. When the touch track passes the touch coordinate A on the sub-boundary 1431 moving into the non-touch area 142, the touch signals cannot be sensed by the touch panel 14. A touch operation of the touch track from the point O to the point A can be, for example, an icon dragging operation under a mouse touch mode.

When a touch signal of the touch coordinate B is sensed by the touch panel 14 in the preset time threshold (e.g., 200 ms), a touch track from the touch coordinate A to the touch coordinate O′ is fitted, and the touch operation of the touch track B to the touch coordinate O′ is the same with the touch operation of the touch track from the touch coordinate O to the touch coordinate A (i.e., a continuous dragging operation from touch coordinate O to touch coordinate O′ under the mouse touch mode).

When a touch signal of the touch coordinate B is not sensed by the touch panel 14 in the preset time threshold (e.g., 200 ms), two independent touch tracks from the touch coordinate B to the touch coordinate O′ and from the touch coordinate O to the touch coordinate A are recognized. The touch operation of the touch track from the touch coordinate B to the touch coordinate O′ is different from the touch operation of the touch track from the touch coordinate O to the touch coordinate A. The touch operation of the touch track from the touch coordinate B to the touch coordinate O′ and the touch operation of the touch track from the touch coordinate O to the touch coordinate A can be under two different touch modes and independently operated. If the touch panel 14 supports a gesture touch mode, the touch operation of the touch track from the touch coordinate B to the touch coordinate O′ can be a gesture operation used to call an application program list. If the touch panel 14 supports a handwriting touch mode, the touch operation of the touch track from the touch coordinate B to the touch coordinate O′ can be a handwriting operation.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may comprise some indication in reference to certain steps. However, the indication used is only to be viewed for identification purposes and not as a suggestion as to an order for the steps.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A control method of touch panel comprising:
S1, sensing a plurality of touch signals in succession on a timeline generated by a continuous touch on the surface of the touch panel, calculating and converting the plurality of touch signals to a plurality of touch coordinates, forming a touch track by the plurality of touch coordinates;
S2, determining if there is a first touch signal sensed on a boundary, if there is, proceeding S3, otherwise returning back to S1;
S3, determining if there is a second touch signal sensed on the timeline in a preset time threshold, if there is, proceeding S4, otherwise proceeding S1, wherein the second signal is generated after the first signal on the timeline;
S4, obtaining a second touch track beginning from the second touch signal, and fitting the first touch track and the second touch track into one complete touch track; and
S5, obtaining a second touch track beginning from the second touch signal, and recognizing the first touch track and the second touch track as two independent tracks;
wherein the touch panel comprises a touch area and a non-touch area, the non-touch area around the touch area, the boundary is between the touch area and the non-touch area, the boundary separates the touch area and the non-touch area, the boundary senses the plurality of touch signals.

2. The design method of claim 1, wherein the S3 comprises:
step(31), starting a counting timer when a first touch coordinate of the first touch signal is located on the boundary;
step(32), stopping the counting timer when the second touch signal is sensed to calculate a time period between the starting and the stopping; and
step(33), comparing the time period with the preset time threshold.

3. The control method of claim 1, wherein the S3 comprises:
step(31), presetting a count down timer, wherein a working time of the count down timer is the preset time threshold;
step(32), starting the count down timer when a first touch coordinate of the first touch signal is located on the boundary; and
step(33), determining whether a second touch coordinate of the second touch signal is located on the boundary during the working time of the count down timer.

4. The control method of claim 1, wherein the preset time threshold is ranged from about 10 ms to about 1000 ms.

5. The control method of claim 1, wherein a touch mode of the one complete touch track is same with the touch mode of the first touch track and the second touch track in the S4.

6. The control method of claim 5, wherein the first touch track and the second touch track correspond two independent touch modes in the S5.

7. The control method of claim 6, wherein the touch modes comprise cursor controlling, gesture controlling, handwriting.

8. The control method of claim 1, wherein the shape of the boundary is a closed square, the boundary comprises four sub-boundaries sequentially connected with each other.

9. The control method of claim 8, wherein the sub-boundary that the first touch signal sensed on in S2 is same with the sub-boundary the second touch signal sensed on in S3.
